(19) United States
(12) Patent Application Publication
(10) Pub. No.: US 2021/0349487 A1
(43) Pub. Date: Nov. 11, 2021

(54) VOLTAGE GENERATING DEVICE

(71) Applicant: Quanta Computer Inc., Taoyuan City (TW)

(72) Inventor: Hung-Ming CHAN, Taoyuan City (TW)

(21) Appl. No.: 17/000,703

(22) Filed: Aug. 24, 2020

(30) Foreign Application Priority Data
May 6, 2020 (TW) 109114972

(51) Int. Cl. G05F 1/575; H02M 3/158; H02M 1/00

(52) U.S. Cl. CPC G05F 1/575; H02M 2001/0009; H02M 1/00; H02M 3/158

(57) ABSTRACT

A voltage generating device including a control circuit, a first capacitor, a processing circuit, and a second capacitor is provided. The control circuit includes an output terminal and a feedback terminal. The output terminal is coupled to an output node. The feedback terminal receives a feedback signal. The first capacitor is coupled to the output node. The processing circuit processes the voltage of the output node to generate the feedback signal. The second capacitor is coupled between the output terminal and the feedback terminal. The control circuit decodes the feedback signal to generate an output signal and provides the output signal to the output terminal.

### CROSS REFERENCE TO RELATED APPLICATIONS

This Application claims priority of Taiwan Patent Application No. 109114972, filed on May 6, 2020, the entirety of which is incorporated by reference herein.

### BACKGROUND OF THE INVENTION

### Field of the Invention

The invention relates to a voltage generating device, and more particularly to a voltage generating device that adjusts the voltage of an output signal according to a feedback signal.

### Description of the Related Art

There are more types of electronic products, and they can perform more functions, thanks to developments of technology. Each electronic product has many electronic elements. The electronic elements need different operation voltages. Therefore, many voltage generating circuits are disposed in each electronic product. The voltage generating circuits generate different output voltages for different electronic elements. However, when the output voltage generated by the voltage generating circuit has a large amount of jitter, the operations of the electronic elements are affected by the jitter.

### BRIEF SUMMARY OF THE INVENTION

In accordance with an embodiment of the disclosure, a voltage generating device comprises a control circuit, a first capacitor, a processing circuit, and a second capacitor. The control circuit comprises an output terminal and a feedback terminal. The output terminal is coupled to an output node. The feedback terminal receives a feedback signal. The first capacitor is coupled to the output node. The processing circuit processes the voltage of the output node to generate the feedback signal. The second capacitor is coupled between the output terminal and the feedback terminal. The control circuit decodes the feedback signal to generate an output signal and provides the output signal to the output terminal.

### BRIEF DESCRIPTION OF THE DRAWINGS

The invention can be more fully understood by referring to the following detailed description and examples with references made to the accompanying drawings, wherein:

FIG. 1A is a schematic diagram of an exemplary embodiment of a voltage generating device, according to various aspects of the present disclosure.

FIG. 1B is a schematic diagram of another exemplary embodiment of the voltage generating device, according to various aspects of the present disclosure.

FIG. 2A is a schematic diagram of another exemplary embodiment of the voltage generating device, according to various aspects of the present disclosure.

FIG. 2B is a schematic diagram of another exemplary embodiment of the voltage generating device, according to various aspects of the present disclosure.

FIG. 3 is a schematic diagram of an exemplary embodiment of a sensing circuit, according to various aspects of the present disclosure.

FIG. 4A is a schematic diagram of another exemplary embodiment of the voltage generating device, according to various aspects of the present disclosure.

FIG. 4B is a schematic diagram of another exemplary embodiment of the voltage generating device, according to various aspects of the present disclosure.

FIG. 5 is a comparison diagram of the waveform of an output node of the present disclosure and a conventional waveform.

FIG. 6 is a comparison diagram of a feedback signal of the present disclosure and a conventional feedback signal.

FIG. 7 is a comparison diagram of an output signal of the present disclosure and a conventional output signal.

### DETAILED DESCRIPTION OF THE INVENTION

The present invention will be described with respect to particular embodiments and with reference to certain drawings, but the invention is not limited thereto and is only limited by the claims. The drawings described are only schematic and are non-limiting. In the drawings, the size of some of the elements may be exaggerated for illustrative purposes and not drawn to scale. The dimensions and the relative dimensions do not correspond to actual dimensions in the practice of the invention.

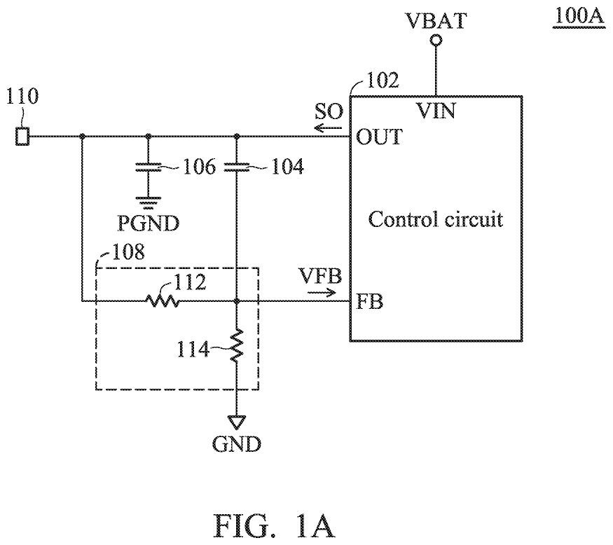

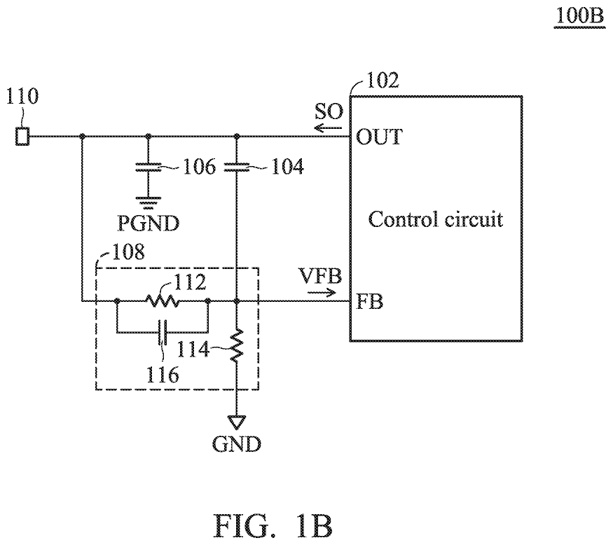

FIG. 1A is a schematic diagram of an exemplary embodiment of a voltage generating device, according to various aspects of the present disclosure. As shown in FIG. 1A, the voltage generating device 100A comprises a control circuit 102, capacitors 104 and 106, and a processing circuit 108. The control circuit 102 comprises an output terminal OUT and a feedback terminal FB. The output terminal OUT is configured to output an output signal SO. The feedback terminal FB is configured to receive a feedback signal VFB. In this embodiment, the control circuit 102 decodes the feedback signal VFB to generate the output signal SO and provides the output signal SO to the output terminal OUT. The type of control circuit 102 is not limited in the present disclosure. In one embodiment, the control circuit 102 is a linear regulator, such as a low dropout regulator (LDO). In other embodiments, the control circuit 102 further comprise an input terminal VIN to receive an input voltage VBAT. In this case, the control circuit 102 adjusts the input voltage VBAT according to the feedback signal VFB and uses the adjusted voltage as an output signal SO.

The capacitor 104 is coupled between the output terminal OUT and the feedback terminal FB. In this embodiment, the capacitor 104 is ripple injection capacitor to arise small noise from the feedback signal VFB such that the control circuit 102 is capable of obtaining the better waveform from the feedback terminal FB.

The capacitor 106 is coupled between an output node 110 and a ground terminal PGND. In this embodiment, the capacitor 106 is a polymer aluminum capacitor. Since the polymer aluminum capacitor has low equivalent series resistance (ESR), the capacitor 106 has better filtering function to filter the ripple in the voltage of the output node 110. Therefore, when a load is coupled to the output node 110, the load is capable of receiving the voltage that has the low noise.

The processing circuit 108 processes the voltage of the output node 110 to generate the feedback signal VFB to the feedback terminal FB. In this embodiment, the processing circuit 108 is a voltage divider circuit coupled between the output node 110 and a ground terminal GND. As shown in FIG. 1A, the processing circuit 108 comprises resistors 112 and 114. The resistor 112 is coupled between the output node 110 and the feedback terminal FB. The resistor 114 is coupled between the feedback terminal FB and the ground terminal GND.

In one embodiment, the control circuit 102 adjusts the output signal SO according to the feedback signal VFB to maintain the voltage of the output node 110 in a threshold voltage. For example, when the feedback signal VFB is less than a reference voltage, it means that the voltage of the output node 110 is too low. Therefore, the control circuit 102 utilizes the output signal SO to increase the voltage of the output node 110. Conversely, when the feedback signal VFB is higher than the reference voltage, it means that the voltage of the output node 110 is too high. Therefore, the control circuit 102 utilizes the output signal SO to reduce the voltage of the output node 110.

FIG. 1B is a schematic diagram of another exemplary embodiment of the voltage generating device, according to various aspects of the present disclosure. FIG. 1B is similar to FIG. 1A, except that the processing circuit 108 in FIG. 1B further comprises a capacitor 116. The capacitor 116 is connected to the resistor 112 in parallel. In this embodiment, the peak of the ripple of the output signal SO is intensified by the capacitor 116. In one embodiment, the ripple of the output signal SO is similar to a triangular wave.

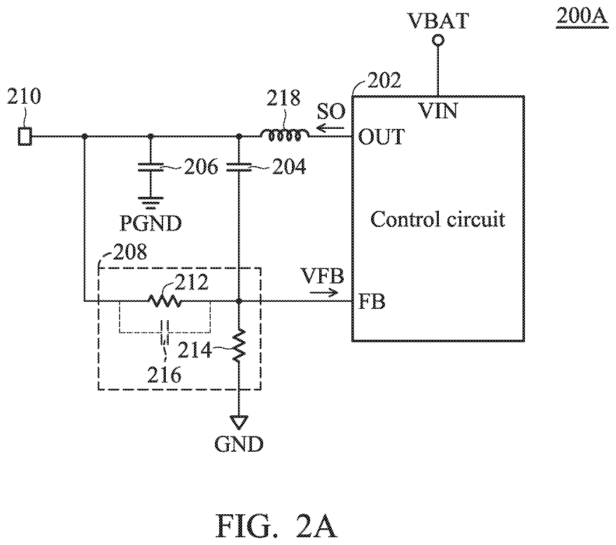

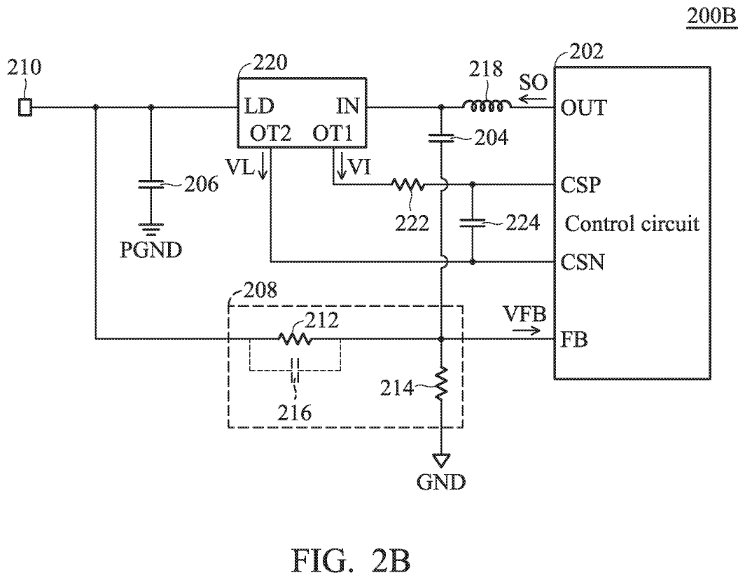

FIG. 2A is a schematic diagram of another exemplary embodiment of the voltage generating device, according to various aspects of the present disclosure. As shown in FIG. 2A, the voltage generating device 200A comprises a control circuit 202, capacitors 204 and 206, a processing circuit 208 and an inductor 218. The control circuit 202 comprises an output terminal OUT and a feedback terminal FB. The output terminal OUT is configured to provide an output signal SO. The feedback terminal FB is configured to receive a feedback signal VFB. In this embodiment, the control circuit 202 decodes the feedback signal VFB to generate the output signal SO.

The type of control circuit 202 is not limited in the present disclosure. In one embodiment, the control circuit 202 is a switch mode power supply (SMPS) converter circuit, such as a buck converter, a boot converter or a buck-boost converter. In some embodiment, the control circuit 202 further comprises an input terminal VIN configured to receive an input voltage VBAT. The control circuit 202 adjusts the input voltage VBAT according to the feedback signal VFB and uses the adjusted voltage as an output signal SO. The control circuit 202 utilizes the output signal SO to control the current passing through the inductor 218 such that the voltage of the output node 210 is adjusted.

The inductor 218 is coupled between the output node 210 and the output terminal OUT. In this embodiment, the inductor 218 is connected to the capacitor 204 in series and between the output terminal OUT and the feedback terminal FB. The capacitor 206 is coupled between the output node 210 and the ground terminal PGND. The processing circuit 208 is coupled between the output node 210 and the feedback terminal FB. Since the features of the capacitors 204 and 206 and the processing circuit 208 are the same as the features of the capacitors 104 and 106 and the processing circuit 108 of FIG. 1, the descriptions of the features of the capacitors 204 and 206 and the processing circuit 208 are omitted. In other embodiments, the processing circuit 208 further comprises a capacitor 216. In this case, the capacitor 216 is connected to the resistor 212 in parallel. Since the feature of the capacitor 216 is the same as the feature of the capacitor 116 shown in FIG. 1B, the description of the feature of the capacitor 216 is omitted.

FIG. 2B is a schematic diagram of another exemplary embodiment of the voltage generating device, according to various aspects of the present disclosure. FIG. 2B is similar to FIG. 2A, except that the voltage generating device 200B further comprises a sensing circuit 220. The sensing circuit 220 is coupled between the output node 210 and the inductor 218 to detect the current passing through the output node 210. In one embodiment, the sensing circuit 220 is a current detector.

In this embodiment, the sensing circuit 220 has an input terminal IN, a load terminal LD and output terminals OT1 and OT2. The input terminal IN is coupled to the capacitor 204 and the inductor 218. The load terminal LD is coupled to the capacitor 206 and the output node 210. The output terminal OT1 provides the voltage VIN of the input terminal IN to the sensing terminal CSP of the control circuit 202. The output terminal OT2 provides the voltage VLD of the load terminal LD to the sensing terminal CSN of the control circuit 202. The control circuit 202 calculates and determines the current passing through the output node 210 according to the difference between the voltages VIN and VLD. In other embodiments, the voltage generating device 200B further comprises a resistor 222 and a capacitor 224. The resistor 222 is coupled between the output terminal OT1 and the sensing terminal CSP. The capacitor 224 is coupled between the sensing terminals CSP and CSN.

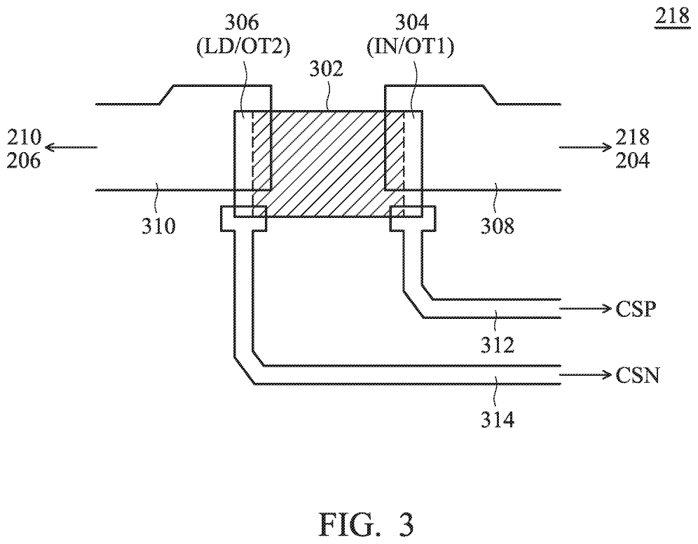

FIG. 3 is a schematic diagram of an exemplary embodiment of a sensing circuit, according to various aspects of the present disclosure. In this embodiment, the sensing circuit 220 comprises a current divider resistor 302. The current divider resistor 302 comprises a first terminal 304 and a second terminal 306. The first terminal 304 serves as the input terminal IN and the output terminal OT1. The second terminal 306 serves as the load terminal LD and the output terminal OT2.

The track 308 is configured to electrically connect the first terminal 304, the inductor 218 and the capacitor 204. The track 310 is configured to electrically connect the second terminal 306, the output node 210 and the capacitor 206. The track 312 is configured to electrically connect the first terminal 304 and the sensing terminal CSP. The track 314 is configured to electrically connect the second terminal 306 to the sensing terminal CSN.

In this embodiment, the sensing circuit 220 is a Kelvin connection circuit. In this case, the capacitor 204 shown in FIG. 2B is coupled between the front-end (i.e., the first terminal 204) of the Kelvin connection circuit and the inductor 218. Therefore, the control circuit 202 identifies the feedback signal VFB of the feedback terminal FB such that the jitter of the output node 210 is reduced.

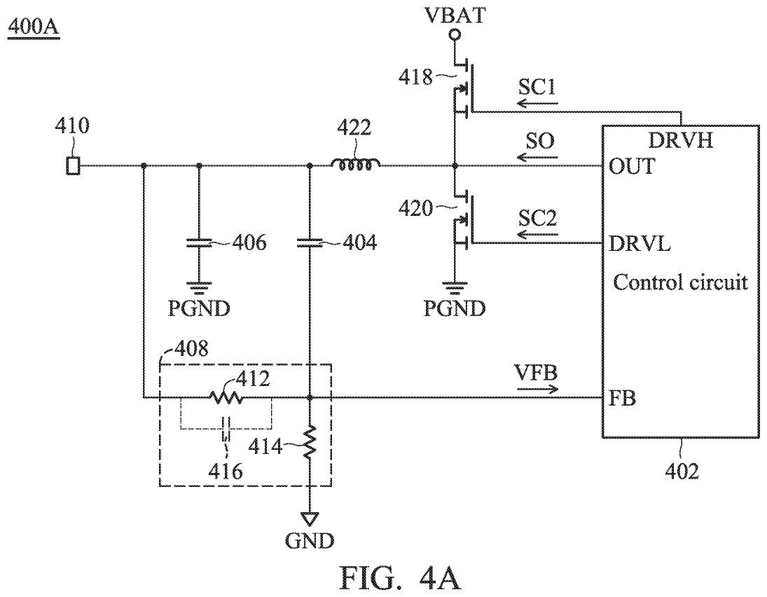

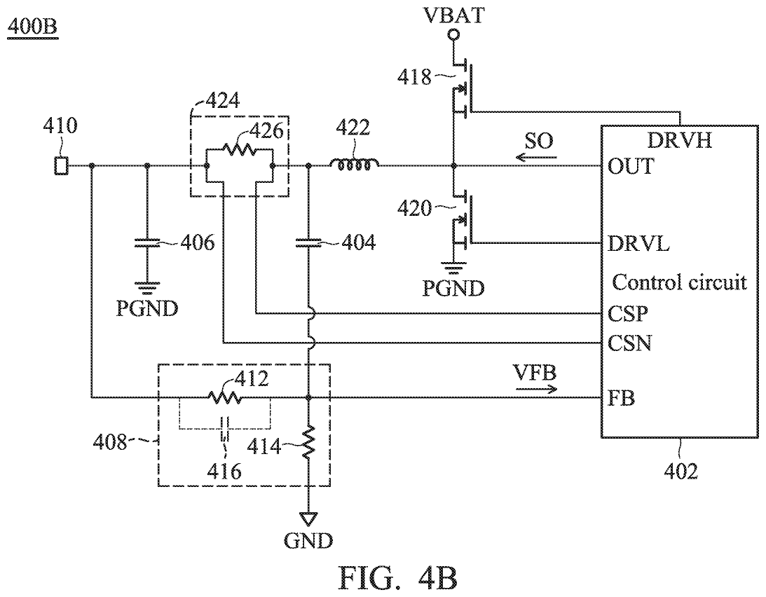

FIG. 4A is a schematic diagram of another exemplary embodiment of the voltage generating device, according to various aspects of the present disclosure. The voltage generating device 400A comprises a control circuit 402, transistors 418 and 420, capacitors 404 and 406, a processing circuit 408 and an inductor 422. The control circuit 402 comprises an output terminal OUT, a feedback terminal FB, driving terminals DRVH and DRVL. The output terminal OUT is configured to provide an output signal SO. The feedback terminal FB is configured to receive a feedback signal VFB. The driving terminal DRVH is configured to output a control signal SC1. The driving terminal DRVL is configured to output a control signal SC2.

The structure of control circuit 402 is not limited in the present disclosure. In one embodiment, the control circuit 402 is a pulse width modulation (PWM) circuit. In this case, the control circuit 402 generates the control signals SC1 and SC2 according to the feedback signal VFB to control the current passing through the inductor 422 and adjust the voltage of the output node 410. For example, the control circuit 402 comprises a comparator (not shown). The comparator compares the feedback signal VFB and a reference voltage to generate a difference signal between the feedback signal VFB and the reference voltage. In this case, a PWM circuit (not shown) changes the pulse width of the output signal SO according to the difference signal. In one embodiment, the comparator is an error amplifier.

The transistor 418 receives an operation voltage VBAT and is coupled to the inductor 422. As shown in FIG. 4A, the drain of the transistor 418 receives the operation voltage VBAT, the source of the transistor 418 is coupled to the output terminal OUT and the inductor 422, and the gate of the transistor 418 receives the control signal SC1. In this embodiment, the transistor 418 is a N-type transistor, but the disclosure is not limited thereto. In other embodiments, the transistor 418 is a P-type transistor.

The transistor 420 is coupled to a ground terminal PGND and the inductor 422. As shown in FIG. 4A, the drain of the transistor 420 is coupled to the source of the transistor 418, the output terminal OUT and the inductor 422. Additionally, the source of the transistor 420 is coupled to the ground terminal PGND, and the gate of the transistor 420 receives the control signal SC2. In this embodiment, the transistor 420 is a N-type transistor, but the disclosure is not limited thereto. In other embodiments, the transistor 420 is a P-type transistor.

The inductor 422 is coupled between the output terminal OUT and the output node 410. Since the features of the inductor 422 is the same as the feature of the inductor 218 shown in FIG. 2A, the description of the feature of the inductor 422 is omitted. Additionally, the capacitor 404 is coupled between the inductor 422 and the feedback terminal FB. In this embodiment, the inductor 422 is connected to the capacitor 404 in series and between the output terminal OUT and the feedback terminal FB. The capacitor 406 is coupled between the output node 410 and the ground terminal PGND. The processing circuit 408 is coupled between the output node 410 and the ground terminal GND and is coupled to the feedback terminal FB. The processing circuit 408 generates the feedback signal VFB according to the voltage of the output node 410. Since the features of the capacitors 404 and 406 and the processing circuit 408 are the same as the features of the capacitors 104 and 106 and the processing circuit 108 of FIG. 1A, the descriptions of the features of the capacitors 404 and 406 and the processing circuit 408 are omitted.

FIG. 4B is a schematic diagram of another exemplary embodiment of the voltage generating device, according to various aspects of the present disclosure. FIG. 4B is similar to FIG. 4A, except that the voltage generating device 400B shown in FIG. 4B further comprises a sensing circuit 424. The sensing circuit 424 is configured to detect the current passing through the inductor 422. The structure of sensing circuit 424 is not limited in the present disclosure. In this embodiment, the sensing circuit 424 comprises a current divider resistor 426. The current divider resistor 426 is coupled between the inductor 422 and the output node 410 and coupled to the sensing terminals CSP and CSN of the control circuit 402. In this case, the sensing circuit 424 utilizes the Kelvin connection. Since the feature of the sensing circuit 424 is the same as the feature of the sensing circuit 220 of FIG. 2B, the description of the feature of the sensing circuit 424 is omitted.

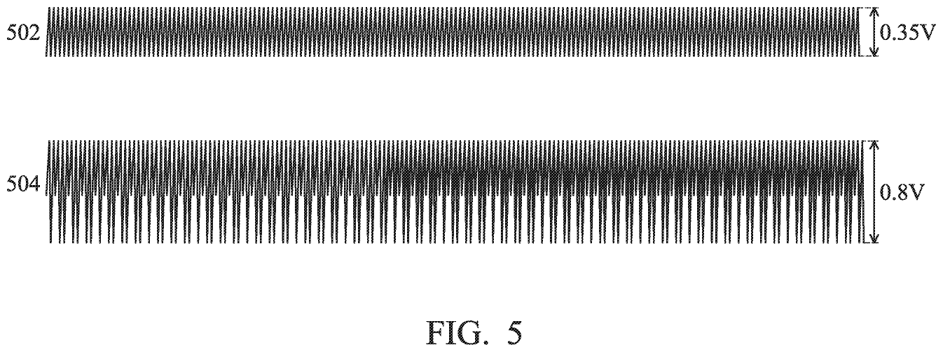

FIG. 5 is a comparison diagram of the waveform of the output node of the present disclosure and a conventional waveform. Taking FIG. 1A as an example, the waveform 502 indicates the waveform of the output node 110. Since the capacitor 106 as the low ESR, the ripple of the waveform 502 is reduced. As shown in FIG. 5, the difference between the maximum voltage and the minimum voltage of the output node 110 is about 0.35V.

The waveform 504 indicates the conventional waveform. In the conventional technology, since the capacitor coupled to an output node is a normal capacitor (e.g., a multi-layer ceramic capacitor (MLCC)), the capacitor coupled to the output node has high ESR. Therefore, the ripple of the waveform 504 is larger than the ripple of the waveform 502. The difference between the maximum voltage and the minimum voltage of the waveform 504 is about 0.8V.

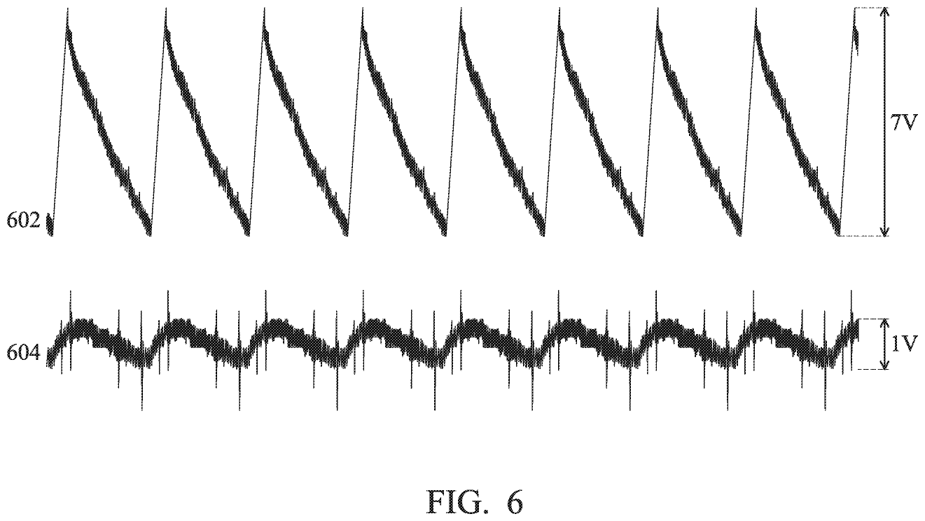

FIG. 6 is a comparison diagram of the feedback signal of the present disclosure and a conventional feedback signal. Taking FIG. 1A as an example, the waveform 602 indicates the waveform of the feedback signal VFB. As shown in FIG. 6, the feedback signal VFB is similar to a triangular wave whose amplitude is above 7V. In this embodiment, since the capacitor 104 injects the ripple component in the feedback signal VFB, the feedback signal VFB has the obvious peaks. Therefore, the control circuit 102 can easily detect the pulse of the feedback signal.

When the capacitor 104 coupled between the output terminal OUT and the feedback terminal FB of the control circuit 102 is omitted, the feedback signal VFB is shown as the waveform 604. The amplitude of the waveform 604 is about 1V and the waveform 604 has many glitches. Since the peak of the waveform 604 is not obvious, the control circuit 102 may use the glitch as a peak to generate an error output signal SO.

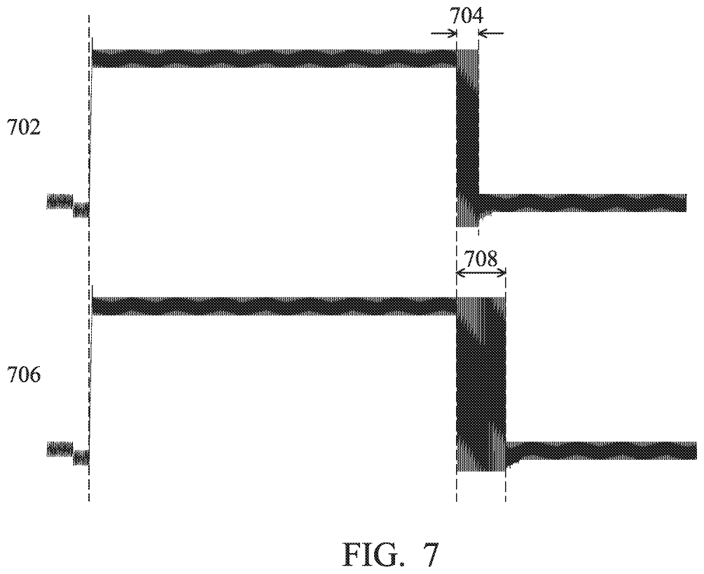

FIG. 7 is a comparison diagram of an output signal of the present disclosure and a conventional output signal. Taking FIG. 4B as an example, the waveform 702 is an overlapping waveform of 500 output signals SO. In this embodiment, since the feedback signal VFB has the obvious peaks, the control circuit 402 is capable of detecting the pulse of the feedback signal VFB easily and then generating the output signal SO according to the feedback signal VFB. As shown in FIG. 7, a jitter region 704 is formed by the falling edges of 500 output signals SO.

When the capacitor 404 coupled between the output terminal OUT and the feedback terminal FB of the control circuit 402 is omitted, since the waveform (e.g., the waveform 604 of FIG. 6) of the feedback signal VFB is not obvious, the control circuit 402 cannot normally identify the feedback signal VFB. Therefore, the jitter region 706 of the conventional output signal (e.g., the waveform 706) is larger than the jitter region 704 of the output signal (e.g., the waveform 702).

Additionally, although the output signal SO (e.g., the waveform 702) of the present disclosure has the jitter effect, the jitter effect does not indicate that the output signal SO is unstable. In fact, the jitter effect is normal in the control loop because the jitter effect can avoid any unexpected event (e.g., noise or hidden) that causes signal deviation. Therefore, a litter jitter does not effect the operation of the control circuit.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). For example, it should be understood that the system, device and method may be realized in software, hardware, firmware, or any combination thereof. Therefore, the scope of the appended claims should be accorded the broadest interpretation so as to encompass all such modifications and similar arrangements.

What is claimed is:

1. A voltage generating device comprising:
a control circuit comprising an output terminal and a feedback terminal, wherein the output terminal is coupled to an output node, and the feedback terminal receives a feedback signal;
a first capacitor coupled to the output node;
a processing circuit processing a voltage of the output node to generate the feedback signal; and
a second capacitor coupled between the output terminal and the feedback terminal,
wherein the control circuit decodes the feedback signal to generate an output signal and provides the output signal to the output terminal.

2. The voltage generating device as claimed in claim 1, wherein the first capacitor is a polymer aluminum capacitor.

3. The voltage generating device as claimed in claim 1, wherein the control circuit is a low dropout linear regulator.

4. The voltage generating device as claimed in claim 1, further comprising:
an inductor coupled between the output node and the output terminal.

5. The voltage generating device as claimed in claim 4, wherein the control circuit is a power converter.

6. The voltage generating device as claimed in claim 4, further comprising:
a first transistor receiving a first operation voltage and coupled to the inductor; and
a second transistor coupled to a ground terminal and the inductor.

7. The voltage generating device as claimed in claim 6, wherein a drain of the first transistor receives the first operation voltage, a source of the first transistor is coupled to the output terminal, and a gate of the first transistor receives a first control signal, and
wherein a drain of the second transistor is coupled to the output terminal, a source of the second transistor is coupled to the ground terminal, and a gate of the second transistor receives a second control signal.

8. The voltage generating device as claimed in claim 7, wherein the control circuit generates the first and second control signals according to a signal from the feedback terminal.

9. The voltage generating device as claimed in claim 6, further comprising:
a sensing circuit coupled between the output node and the inductor to detect a current passing through the output node.

10. The voltage generating device as claimed in claim 9, wherein the sensing circuit is a Kelvin connection circuit.
